(19) United States
(12) Patent Application Publication
(10) Pub. No.: US 2022/0170871 A1
(43) Pub. Date: Jun. 2, 2022

(54) ELECTRODE EVALUATION METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Katsuyuki NAITO, Bunkyo Tokyo (JP); Naomi SHIDA, Minato Tokyo (JP); Yutaka SAITA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/670,926

(22) Filed: Feb. 14, 2022

Related U.S. Application Data
(63) Continuation of application No. PCT/JP2020/029743, filed on Aug. 4, 2020.

(51) Int. Cl. G01N 27/04; G01N 21/59

(52) U.S. Cl. CPC G01N 27/04; G01N 21/59

(57) ABSTRACT

According to one embodiment of the invention, an electrode evaluation method includes applying a voltage to an electrode with at least a part of the electrode including silver in contact with a liquid including an anion. The electrode evaluation method includes measuring a sheet resistance of the electrode after the applying.

### CROSS-REFERENCE TO RELATED APPLICATIONS

This is a continuation application of International Application PCT/3P2020/029743, filed on Aug. 4, 2020; the entire contents of which are incorporated herein by reference.

### FIELD

Embodiment of the invention relates to an electrode evaluation method.

### BACKGROUND

For example, electrodes are used in electronic devices such as solar cells. A method for efficiently evaluating the characteristics of electrodes is desired.

### BRIEF DESCRIPTION OF THE DRAWINGS

FIG. 1 is a flow chart illustrating an electrode evaluation method according to a first embodiment;

FIG. 2 is a schematic view illustrating the electrode evaluation method according to the first embodiment; and

FIG. 3A to FIG. 3D are schematic cross-sectional views illustrating an electrode to which the electrode evaluation method according to the first embodiment is applied.

### DETAILED DESCRIPTION

According to one embodiment of the invention, an electrode evaluation method includes applying a voltage to an electrode with at least a part of the electrode including silver in contact with a liquid including an anion. The electrode evaluation method includes measuring a sheet resistance of the electrode after the applying.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

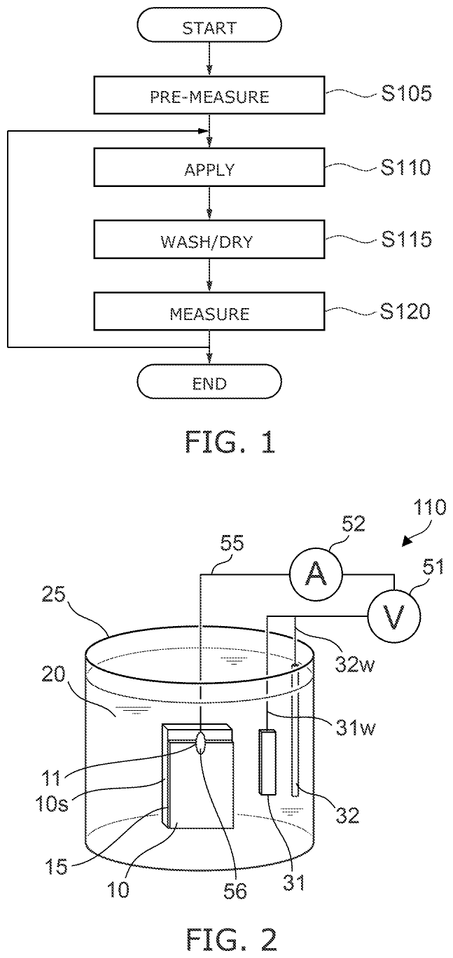

FIG. 1 is a flow chart illustrating an electrode evaluation method according to a first embodiment.

FIG. 2 is a schematic view illustrating the electrode evaluation method according to the first embodiment.

As shown in FIG. 1, the electrode evaluation method according to the embodiment includes an application process (step S110) and a measurement process (step S120). In addition, the electrode evaluation method may further include a pre-measurement process (step S105) and a washing/drying process (step S115), which will be described later. Hereinafter, examples of these processes will be described.

As shown in FIG. 2, in the application process, a voltage is applied to the electrode 10 with at least a part of the electrode 10 to be evaluated in contact with the liquid 20.

The electrode 10 includes silver. For example, the electrode 10 may be provided on the base 10s or the like. The electrode 10 has, for example, light transmission.

For example, the liquid 20 is placed in the container 25. The liquid 20 includes an anion. In one example, the liquid 20 includes water. The liquid 20 is, for example, an aqueous solution. For example, the anion includes a halogen ion. For example, the anion includes a chlorine ion. In one example, the anion includes a chloride ion.

For example, at least a part of the electrode 10 is immersed in the liquid 20. For example, the electrode 10 includes a terminal portion 11. A voltage is applied to the terminal portion 11. For example, a wiring 55 is electrically connected to the terminal portion 11 by a conductive paste 56 or the like. The wiring 55 is electrically connected to the controller 51. In the example of FIG. 2, the ammeter 52 is provided in the wiring 55. The ammeter 52 may be omitted. The controller 51 and the counter electrode 31 are electrically connected by the wiring 31w. The counter electrode 31 is in contact with the liquid 20. In this example, at least a part of the counter electrode 31 is immersed in the liquid 20. The controller 51 includes, for example, a power supply or the like. The controller 51 may include a control circuit.

In the application process, a voltage is applied to the electrode 10 with at least a part of the electrode 10 in contact with the liquid 20. In one example, for example, during at least a part of the application process, the applied voltage is positive relative to the potential of the counter electrode 31 in contact with the liquid 20. The applied voltage is, for example, not less than 0.05 V and not more than 1 V. For example, the applied voltage may be not less than 0.08 V and not more than 0.8 V.

The application time is, for example, not less than 0.1 minutes and not more than 60 minutes. The characteristics of the electrode 10 are changed by such an application process. For example, the electrode 10 deteriorates. The application process promotes a change in the characteristics of the electrode 10.

After such an application process, a sheet resistance of the electrode 10 is measured in the measurement process (step S120 in FIG. 1). The measurement process may include measuring the sheet resistance by a four-probe method. By using the four-probe method, the sheet resistance can be measured stably. For example, the distribution of sheet resistance can be easily measured.

In the embodiment, the characteristics of the electrode 10 can be easily evaluated. By going through the application process as described above, for example, the change in the characteristics (for example, chemical characteristics) of the electrode 10 is accelerated. It is considered that the electrical characteristics (for example, sheet resistance) change with the chemical change. For example, optical characteristics (e.g., transmittance) change with chemical changes. For example, by evaluating changes in electrical characteristics (e.g., sheet resistance), changes in other characteristics (e.g., optical characteristics) can be estimated.

In the embodiment, the application process is carried out before the measurement process. In the application process, the characteristics of the electrode 10 change in a short time. The application process is, for example, an accelerated test. By carrying out the measurement process after performing the application process, a long-term change in the characteristics of the electrode 10 in an actual use state can be evaluated in a short time. According to the embodiment, it is possible to provide an electrode evaluation method capable of efficiently evaluating the characteristics.

The evaluation method according to the embodiment may be applied, for example, when evaluating a sample obtained from a manufacturing lot of the electronic device including the electrode 10. For example, a sampling test is performed. As a result, for example, performance grasping, manufacturing yield, reliability data, etc. regarding the electronic device can be obtained. The evaluation method according to the embodiment may be carried out, for example, at the time of studying the design of the electronic device. The evaluation method according to the embodiment may be carried out, for example, at the time of examining the manufacturing conditions of the electronic device. For example, if the electrode 10 has a defect or the like, the anion (X−) easily arrives at the silver-including portion of the electrode 10 through the defect. At this time, the anion is oxidized by the potential due to the voltage applied to the electrode 10. As a result, for example, the reaction of the following equation (1) occurs. In the following, “X−” is the anion.

Alternatively, silver diffuses, dissolves in the liquid 20, and reacts with the anion. Both of these may occur.

X−+Ag→AgX+e− (1)

When the polarity of the applied voltage is opposite, the reverse reaction of the following equation (2) occurs.

AgX+e−→X−+Ag (2)

A current is observed by the exchange of electrons based on this reaction.

In both the reactions of the above equations (1) and (2), the structure of the electrode 10 changes from the state of the electrode 10 before the voltage is applied. As a result, the sheet resistance of the electrode 10 often increases.

In one example, amperometry can be applied to the application of voltage, for example. In this case, a constant voltage is applied and the current value is detected. In another example, voltammetry can be applied, for example, to the application of voltage. In this case, the current value is measured by changing the voltage. In the embodiment, any of the above methods may be applied to the application of the voltage.

In the embodiment, a voltage may be applied cyclically to detect a change in the response of the current value to accelerate the change in the structure of the electrode 10. For example, in voltammetry, the voltage may be changed with time as a linear function. For example, cyclic voltammetry may be applied. This makes the analysis easier. In the embodiment, by appropriately setting the voltage applied to the electrode 10, for example, generation of oxygen or hydrogen due to the electrolysis of water in the liquid 20 can be suppressed. The voltage is preferably not less than −0.5 V and not more than +0.8 V, for example, based on the potential of the counter electrode 31. For example, when cyclic voltammetry is applied, the voltage change rate is, for example, not less than 2.5 mV/s and not more than 50 mV/s. The voltage change rate may be, for example, not less than 10 mV/s and not more than 25 mV/s. As described above, in the embodiment, the application process may include repeatedly changing the voltage. In embodiments, the application process may include cyclically varying the voltage.

In the embodiment, for example, a positive voltage is applied to the anion and silver to accelerate the deterioration of the electrode 10. In the embodiment, it is possible to estimate not only the deterioration with respect to the anion but also the deterioration due to defects due to oxygen, water, sulfur components and the like in a shorter time.

For example, the ease of reaction between the electrode 10 and the anion and the ease of elution of silver change depending on a concentration of the anion. For example, a higher concentration of the anion increases sensitivity. In one example, the concentration of the anion is, for example, not less than 0.002 mol/L (mol/liter) and not more than 2 mol/L.

In the application process, nitrogen gas may be introduced into the liquid 20. For example, bubbles of nitrogen gas may be introduced into the liquid 20. For example, silver reacts with oxygen to oxidize. By introducing nitrogen gas into the liquid 20, for example, the reaction between silver and oxygen is suppressed. For example, the application process may be carried out in a nitrogen gas atmosphere. In one example, the temperature in the application process is, for example, not lower than 15° C. and not higher than 30° C.

In the embodiment, the anion includes, for example, at least one selected from the group consisting of a halogen ion, a hydroxide ion, a sulfide ion and a carbonate ion. Reactivity with silver is high in the halogen ion. As the anion, for example, at least one selected from the group consisting of a chloride ion, a bromide ion, an iodide ion, and a fluoride ion may be used. By selecting from these ions, for example, the size of anion or the reaction potential can be changed. Reactivity with silver is high in hydroxide ion. By using hydroxide ion, for example, it becomes easy to evaluate the deterioration of the electrode 10 in an alkaline state. By using sulfide ion, for example, it becomes easy to evaluate the deterioration of the electrode 10 due to the hydrogen sulfide component in the air. By using carbonate ion, for example, it becomes easy to evaluate the deterioration of the electrode 10 due to the carbon dioxide component in the air.

For example, the electrode 10 is used in an electronic device such as a solar cell, an organic EL element, or an optical sensor. In such an application, for example, the electrode 10 including silver may be used. For example, as the electrode 10, for example, ITO (Indium Tin Oxide)/(Ag or Ag alloy)/ITO is used. For example, silver nanowires may be used as the electrode 10. These materials provide, for example, low resistance and high light transmittance.

In the electrode 10 including silver, silver may be deteriorated by the halogen ion, the hydroxide ion, the sulfide ion, the carbonate ion and the like. Silver is easy to migrate. When silver migrates, it reacts with, for example, water to form silver oxide. As a result, the electrode 10 is deteriorated. Further, the members other than the electrode 10 included in the electronic device are liable to deteriorate. For example, when silver arrives at the active portion included in the electronic device, the performance of the active portion deteriorates. For example, if a metal ion such as an indium or a halogen ion enters the photoelectric conversion layer, the performance of the active portion deteriorates. For example, when elements included in the active portion (including, for example, ion) moves from the active portion, the performance of the active portion deteriorates.

For example, a method for efficiently evaluating the characteristics of the electrode 10 including silver in a short time is desired. According to the embodiment, an electrode evaluation method capable of efficiently evaluating the characteristics of the electrode 10 is provided.

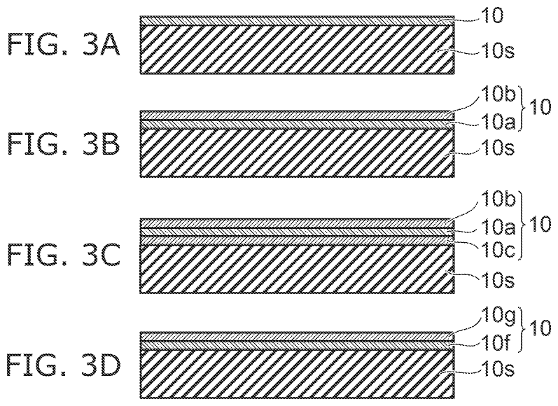

FIG. 3A to FIG. 3D are schematic cross-sectional views illustrating an electrode to which the electrode evaluation method according to the first embodiment is applied.

As shown in FIG. 3A, the electrode 10 may be provided on the base 10s. The base 10s may contain, for example, glass. The base 10s may include, for example, a resin.

In one example, the electrode 10 includes silver nanowires. Silver nanowires include silver or silver alloys. The electrode 10 may include a silver layer. The electrode 10 may include a silver alloy layer.

As shown in FIG. 3B, in one example, the electrode 10 includes a first layer 10a and a second layer 10b. The second layer 10b is stacked with the first layer 10a. The stacking order is arbitrary. The first layer 10a includes silver. The first layer 10a may include an alloy including silver. The second layer 10b includes an oxide. The second layer 10b includes, for example, an oxide conductor (for example, ITO). The first layer 10a and the second layer 10b have light transmission.

As shown in FIG. 3C, the electrode 10 may include the first layer 10a, the second layer 10b, and a third layer 10c. The first layer 10a is between the second layer 10b and the third layer 10c. The first layer 10a includes silver. The first layer 10a may include a silver alloy. The second layer 10b and the third layer 10c include, for example, the oxide conductor (for example, ITO). The first to third layers 10a to 10c have light transmittance.

As shown in FIG. 3D, the electrode 10 may include a first film 10f and a second film 10g. The first film 10f includes silver. The first film 10f has light transmittance. The second film 10g is stacked with the first film 10f. For example, the first film 10f is between the base 10s and the second film 10g. The second film 10g includes, for example, at least one selected from the group consisting of graphene, organic semiconductors and inorganic semiconductors. The second film 10g including these materials has, for example, a passivation effect on the anion. The electrode 10 including the second film 10g may be evaluated.

When the electrode 10 includes an alloy, the alloy includes, for example, at least one selected from the group consisting of Pd, Pt, Au, Sn, Zn and Cu, and silver.

A thickness of the silver-including portion of the electrode 10 is, for example, not less than 2 nm and not more than 20 nm. When the thickness is not less than 2 nm, for example, low electrical resistance can be obtained. When the thickness is not more than 20 nm, for example, high light transmittance can be obtained. The thickness is more preferably not less than 3 nm and not more than 15 nm, for example.

When the electrode 10 includes silver nanowires, an average diameter of the silver nanowires is, for example, not less than 20 nm and not more than 200 nm. High stability is obtained when the average diameter is not less than 20 nm. When the average diameter is not more than 200 nm, high light transmittance can be obtained.

Information about the thickness of the electrode 10 (and the layers or films included therein) can be obtained, for example, by observation with an electron microscope. The diameter of the silver nanowires can be obtained by observation with, for example, an electron microscope and the like. The observation may be made, for example, on a surface or cross section of the electrode 10.

The diameter of the silver nanowires may be, for example, a width in a planar image of the silver nanowires. When the width of the silver nanowires varies in one silver nanowire, the average of the measured values at three positions in one silver nanowire may be used as the diameter of the silver nanowires. As the average value of these values, for example, the average value of the values obtained at 50 random measurement points (for example, the arithmetic average) may be used.

In the embodiment, in one example of the application process, a side surface 15 of the electrode 10 may be brought into contact with the liquid 20 (see FIG. 2). In another example of the application process, a part of the electrode 10 may be brought into contact with the liquid 20 without contacting the side surface 15 of the electrode 10 with the liquid 20. For example, by providing a cover material that covers the side surface 15, the side surface 15 can be prevented from coming into contact with the liquid 20. The side surface 15 may be, for example, a cut surface of the electrode 10. For example, resistance on the cut surface can be evaluated efficiently. The evaluation based on the cut surface provides information on the deterioration of the characteristics of the side surface 15 (for example, the end face) formed by, for example, a scribe.

As shown in FIG. 2, a reference electrode 32 may be provided in the embodiment. The reference electrode 32 is in contact with the liquid 20. The reference electrode 32 is immersed in, for example, the liquid 20. The reference electrode 32 is electrically connected to the controller 51 by, for example, a wiring 32w. In the example of FIG. 2, the wiring 32w is electrically connected to the wiring 31w. The reference electrode 32 provides, for example, a reference point for the potential, improving the stability and reproducibility of the measurement.

For example, the controller 51 applies a voltage between the counter electrode 31 (and the reference electrode 32) and the electrode 10. The voltage is controlled by the controller 51. For example, the ammeter 52 may measure the current flowing between the counter electrode 31 (and the reference electrode 32) and the electrode 10. The current is based on the reaction between silver included in the electrode 10 and the anion, or the dissolution of a silver ion.

The counter electrode 31 includes, for example, at least one selected from the group consisting of platinum, gold, and carbon electrodes. These materials are chemically stable. The counter electrode 31 preferably includes platinum.

As described above, in the application process, for example, a voltage is applied to at least a part of the electrode 10 via the conductive paste 56. The conductive paste 56 is, for example, a silver paste. By applying a voltage by such a method, for example, a contact resistance becomes small. For example, preparation of a sample becomes easy.

In the embodiment, when the sheet resistance is measured by the four-probe method, four needles are arranged along one direction. A distance between the two closest needles is, for example, about 1 mm. The short interval makes it easy to measure the distribution of sheet resistance, for example. By using the four-probe method, for example, even when the electrode 10 includes the second film 10g, it is easy to measure the sheet resistance.

As described above, in the application process, for example, a voltage is applied to at least a part of the electrode 10 via the conductive paste 56. The conductive paste 56 is, for example, a silver paste. By applying a voltage by such a method, for example, a contact resistance becomes small. For example, preparation of a sample becomes easy.

As shown in FIG. 1, the electrode evaluation method according to the embodiment may further include a pre-measurement process (step S105) for measuring the sheet resistance of the electrode 10 before the application process. By evaluating the characteristics of the electrode 10 in the initial state, more appropriate evaluation results can be obtained.

As shown in FIG. 1, the electrode evaluation method according to the embodiment may further include a process (washing/drying process) (step) of washing the electrode 10 and drying it after washing between the application process and the measurement process. The electrode 10 in a stable state can be evaluated by washing and drying. For example, more accurate evaluation results can be obtained.

As shown in FIG. 1, the application process and the measurement process may be repeated. This provides information about the extent of the deterioration. For example, more accurate evaluation results can be obtained.

In the embodiment, the evaluation method may further include a transmittance measurement process of measuring a change in the light transmittance of the electrode 10.

An example of evaluation will be described below. First evaluation example

The electrode 10 is provided on the base 10s. The base 10s is a PET film having a thickness of about 100 μm. The electrode 10 has the configuration illustrated in FIG. 3C. The first layer 10a includes an alloy including silver and Pd. A thickness of the first layer 10a is 5 nm. The second layer 10b contains ITO. A thickness of the second layer 10b is 45 nm. The third layer 10c includes ITO. A thickness of the third layer 10c is 45 nm. The sheet resistance (initial value) of the electrode 10 before the application process is 8 Ω/□ to 9 Ω/□. The electrode 10 is cut into a size of 1.5 cm×4 cm. The wiring 55 (titanium wire) is fixed to the electrode 10 by the conductive paste 56 (silver paste). The portion provided with the conductive paste 56 is protected by a silicone tape. The electrode 10 includes four side surfaces. The liquid 20 is an aqueous solution of sodium chloride. A concentration of the anion in the liquid 20 is 0.5 mol/L.

In a first sample, short two of the four side surfaces are protected by the silicone tape. In this state, a voltage is applied to the electrode 10 by cyclic voltammetry using an electrode evaluation device 110 illustrated in FIG. 2. In the electrode evaluation device 110, the counter electrode 31 is a platinum plate. The reference electrode 32 is a silver/silver chloride electrode. Upon application of the voltage, the voltage varies between −0.5 V and +0.8 V. A rate of change in the voltage is 25 mV/s. The number of voltage changes is 15.

The first sample is washed with water and dried. The sheet resistance measured thereafter is 9 Ω/□ to 10 Ω/□.

### Second Evaluation Example

In the second evaluation example, the electrode 10 has the configuration illustrated in FIG. 3D. The second film 10g includes graphene. Graphene is formed, for example, by coating an aqueous dispersion of graphene oxide to form a film and reducing it with hydrated hydrazine vapor. The first film 10f is a silver thin film having a thickness of 20 nm. The sheet resistance (initial value) of the electrode 10 before the application step is 3 Ω/□ to 4 Ω/□. The electrode 10 is cut into a size of 1.5 cm×4 cm. The wiring 55 (titanium wire) is fixed to the electrode 10 by the conductive paste 56 (silver paste). The portion provided with the conductive paste 56 is protected by the silicone tape. The electrode 10 includes four side surfaces. The liquid 20 is an aqueous solution of sodium chloride. The concentration of the anion in the liquid 20 is 0.05 mol/L. In a second sample, the four side surfaces are protected by the silicone tape. In this state, a voltage is applied to the electrode 10 by cyclic voltammetry. Upon application of the voltage, the voltage varies between −0.5 V and +0.8 V. The rate of change in the voltage is 25 mV/s. The number of voltage changes is 15.

The second sample is washed with water and dried. The sheet resistance measured thereafter is 6 Ω/□ to 7 Ω/□.

### Third Evaluation Example

In the third evaluation example, the electrode 10 is provided on the base 10s. The substrate 10s is a PET film having a thickness of about 100 μm. The electrode 10 has the configuration illustrated in FIG. 3C. The first layer 10a is silver, and the thickness of the first layer 10a is 5 nm. The second layer 10b includes ITO. The thickness of the second layer 10b is 45 nm. The third layer 10c includes ITO. The thickness of the third layer 10c is 45 nm. The sheet resistance (initial value) of the electrode 10 before the application step is 7 Ω/□ to 8 Ω/□. The transmittance of the electrode 10 at a wavelength of 550 nm is 85%. The electrode 10 is cut into a size of 1.5 cm×4 cm.

The wiring 55 (titanium wire) is fixed to the electrode 10 by the conductive paste 56 (silver paste). The portion provided with the conductive paste 56 is protected by the silicone tape. The electrode 10 includes four side surfaces. The liquid 20 is an aqueous solution of sodium chloride. The concentration of the anion in the liquid 20 is 0.5 mol/L.

In a third sample, short two of the four side surfaces are protected by the silicone tape. In this state, a voltage is applied to the electrode 10 by cyclic voltammetry. Upon application of the voltage, the voltage varies between −0.5 V and +0.8 V. The rate of change in the voltage is 25 mV/s. The number of voltage changes is 15.

The third sample is washed with water and dried. The sheet resistance measured thereafter is 50 Ω/□ to 55 Ω/□. The transmittance of the electrode 10 at a wavelength of 550 nm is 75%.

### Fourth Evaluation Example

In the fourth evaluation example, the electrode 10 has the configuration illustrated in FIG. 3D. The second film 10g includes graphene. Graphene is formed, for example, by coating an aqueous dispersion of graphene oxide to form a film and reducing it with hydrated hydrazine vapor. The first film 10f is a silver nanowire film having a diameter of 20 nm to 40 nm. The sheet resistance (initial value) of the electrode 10 before the application process is 10 Ω/□ to 11 Ω/□. The electrode 10 is cut into a size of 1.5 cm×4 cm. The wiring 55 (titanium wire) is fixed to the electrode 10 by the conductive paste 56 (silver paste). The portion provided with the conductive paste 56 is protected by the silicone tape. The electrode 10 includes four side surfaces. The liquid 20 is an aqueous solution of sodium chloride. The concentration of the anion in the liquid 20 is 0.5 mol/L.

In a fourth sample, short two of the four side surfaces are protected by the silicone tape. In this state, a voltage is applied to the electrode 10 by cyclic voltammetry. Upon application of the voltage, the voltage varies between −0.5 V and +0.8 V. The rate of change in the voltage is 25 mV/s. The number of voltage changes is 15.

The fourth sample is washed with water and dried. The sheet resistance measured thereafter is 15 Ω/□ to 17 Ω/□.

### Fifth Evaluation Example

The above third sample is immersed in a sodium chloride aqueous solution having an anion concentration of 0.5 mol/L at room temperature for 3 days. At this time, no voltage is applied to the electrode 10. After this, the sample is washed with water and dried. The sheet resistance obtained by this method is 8 Ω/□ to 9 Ω/□. Compared with the result of the third evaluation example above, the change is very small.

### Second Embodiment

The second embodiment relates to an electrode evaluation device. The electrode evaluation device 110 (see FIG. 2) includes, for example, the container 25 capable of holding the liquid 20 including an anion, and a controller 51 for applying a voltage to the electrode 10. According to the electrode evaluation device 110, the characteristics of the electrode 10 can be changed in a short time. According to the electrode evaluation device 110, it is possible to provide an electrode evaluation device which is possible to efficiently evaluate the characteristics.

According to the embodiment, the characteristics (for example, resistance to anion) of the electrode 10 used in an electronic device such as a solar cell can be efficiently evaluated in a short time. For example, the characteristics of the electrode 10 in the actual use state of the electronic device can be efficiently evaluated.

The embodiment may include the following configurations (e.g., technical proposals).

### Configuration 1

An electrode evaluation method, comprising:
applying a voltage to an electrode with at least a part of the electrode including silver in contact with a liquid including an anion; and
measuring a sheet resistance of the electrode after the applying.

### Configuration 2

The electrode evaluation method according to Configuration 1, wherein
the electrode has light transmission.

### Configuration 3

The electrode evaluation method according to Configuration 1 or 2, wherein
the liquid includes water.

### Configuration 4

The electrode evaluation method according to Configuration 1, wherein
the anion includes a halogen ion.

### Configuration 5

The electrode evaluation method according to Configuration 1, wherein
the anion includes a chloride ion.

### Configuration 6

The electrode evaluation method according to any one of Configurations 1 to 5, wherein
the electrode includes a nanowire including silver or a silver alloy.

### Configuration 7

The electrode evaluation method according to any one of Configurations 1 to 6, wherein
the electrode includes a first layer including silver, and a second layer stacked with a layer including the silver, the second layer including an oxide.

### Configuration 8

The electrode evaluation method according to any one of Configurations 1 to 7, wherein
the voltage is not more than 0.8 V.

### Configuration 9

The electrode evaluation method according to any one of Configurations 1 to 8, wherein
the applying includes repeatedly changing the voltage.

### Configuration 10

The electrode evaluation method according to any one of Configurations 1 to 9, further comprising:
measuring a transmittance for measuring a change in a light transmittance of the electrode.

### Configuration 11

The electrode evaluation method according to any one of Configurations 1 to 10, further comprising:
pre-measuring for measuring the sheet resistance of the electrode before the applying.

### Configuration 12

The electrode evaluation method according to any one of Configurations 1 to 11, further comprising:
washing the electrode to dry after the washing between the applying and the measuring.

### Configuration 13

The electrode evaluation method according to any one of Configurations 1 to 12, wherein
the applying and the measuring are repeated.

### Configuration 14

The electrode evaluation method according to any one of Configurations 1 to 13, wherein
the electrode includes a terminal portion to which the voltage is applied, and
in the applying, a part of the electrode is brought into contact with the liquid without contacting the terminal portion with the liquid.

### Configuration 15

The electrode evaluation method according to any one of Configurations 1 to 14, wherein
in the applying, a voltage is applied to the at least a part of the electrode via a conductive paste.

### Configuration 16

The electrode evaluation method according to any one of Configurations 1 to 15, wherein
in the applying, a part of the electrode is brought into contact with the liquid without contacting a side surface of the electrode with the liquid.

### Configuration 17

The electrode evaluation method according to any one of Configurations 1 to 15, wherein
in the applying, a side surface of the electrode is brought into contact with the liquid.

### Configuration 18

The electrode evaluation method according to any one of Configurations 1 to 17, wherein
the electrode includes a first film including silver and a second film stacked with the first film, and
the second film includes at least one selected from the group consisting of graphene, an organic semiconductor or an inorganic semiconductor.

### Configuration 19

The electrode evaluation method according to any one of Configurations 1 to 18, wherein
the measuring includes measuring the sheet resistance by a four-probe method.

### Configuration 20

The electrode evaluation method according to any one of Configurations 1 to 19, wherein
during at least a part of the applying, the voltage is positive relative to a potential of a counter electrode.

According to the embodiment, an electrode evaluation method can be provided in which characteristics are possible to be efficiently evaluated.

Hereinabove, exemplary embodiments of the invention are described with reference to specific examples. However, the embodiments of the invention are not limited to these specific examples. For example, one skilled in the art may similarly practice the invention by appropriately selecting specific configurations of components used in electrode evaluation methods such as electrodes, liquids, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all electrode evaluation methods practicable by an appropriate design modification by one skilled in the art based on the electrode evaluation methods described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An electrode evaluation method, comprising:
applying a voltage to an electrode with at least a part of the electrode including silver in contact with a liquid including an anion; and
measuring a sheet resistance of the electrode after the applying.

2. The electrode evaluation method according to claim 1, wherein
the electrode has light transmission.

3. The electrode evaluation method according to claim 1, wherein
the liquid includes water.

4. The electrode evaluation method according to claim 1, wherein
the anion includes a halogen ion.

5. The electrode evaluation method according to claim 1, wherein
the anion includes a chloride ion.

6. The electrode evaluation method according to claim 1, wherein
the electrode includes a nanowire including silver or a silver alloy.

7. The electrode evaluation method according to claim 1, wherein
the electrode includes a first layer including silver, and a second layer stacked with a layer including the silver, the second layer including an oxide.

8. The electrode evaluation method according to claim 1, wherein
the voltage is not more than 0.8 V.

9. The electrode evaluation method according to claim 1, wherein
the applying includes repeatedly changing the voltage.

10. The electrode evaluation method according to claim 1, further comprising:
measuring a transmittance for measuring a change in a light transmittance of the electrode.

11. The electrode evaluation method according to claim 1, further comprising:
pre-measuring for measuring a sheet resistance of the electrode before the applying.

12. The electrode evaluation method according to claim 1, further comprising:
washing the electrode to dry after the washing between the applying and the measuring.

13. The electrode evaluation method according to claim 1, wherein
the applying and the measuring are repeated.

14. The electrode evaluation method according to claim 1, wherein
the electrode includes a terminal portion to which the voltage is applied, and
in the applying, a part of the electrode is brought into contact with the liquid without contacting the terminal portion with the liquid.

15. The electrode evaluation method according to claim 1, wherein
in the applying, a voltage is applied to the at least a part of the electrode via a conductive paste.

16. The electrode evaluation method according to claim 1, wherein
in the applying, a part of the electrode is brought into contact with the liquid without contacting a side surface of the electrode with the liquid.

17. The electrode evaluation method according to claim 1, wherein
in the applying, a side surface of the electrode is brought into contact with the liquid.

18. The electrode evaluation method according to claim 1, wherein
the electrode includes a first film including silver and a second film stacked with the first film, and
the second film includes at least one selected from the group consisting of graphene, an organic semiconductor or an inorganic semiconductor.

19. The electrode evaluation method according to claim 1, wherein
the measuring includes measuring the sheet resistance by a four-probe method.

20. The electrode evaluation method according to claim 1, wherein
during at least a part of the applying, the voltage is positive relative to a potential of a counter electrode.
